(19) United States
(12) Patent Application Publication
(10) Pub. No.: US 2015/0061948 A1
(43) Pub. Date: Mar. 5, 2015

(54) ELECTRONIC DEVICE

(71) Applicant: ASUSTeK COMPUTER INC., Taipei (TW)

(72) Inventors: Chien-Ming HSU, TAIPEI (TW); Wei-Hsin SHIH, TAIPEI (TW)

(21) Appl. No.: 14/469,605

(22) Filed: Aug. 27, 2014

(30) Foreign Application Priority Data
Aug. 30, 2013 (TW) 102131342

(51) Int. Cl. H01Q 1/24; H01Q 5/00

(52) U.S. Cl. CPC H01Q 1/243; H01Q 5/0027
USPC 343/720; 343/700 MS

(57) ABSTRACT

An electronic device includes a first conducting element, a second conducting element and a multihand antenna. The multihand antenna includes a first radiating part and a first coupling metal part. At least a part of the first radiating part is disposed between the first conducting element and the second conducting element. The first coupling metal part parallels to the first radiating part and is connected to a ground. The electronic device can reduce the affection of metal components in a portable device on the antenna, and enables the antenna to operate at more and wider frequency bands.

### CROSS-REFERENCE TO RELATED APPLICATION

This application claims the priority benefit of TW application serial No. 102131342, filed on Aug. 30, 2013. The entirety of the above-mentioned patent applications are hereby incorporated by reference herein and made a part of specification.

### BACKGROUND OF THE INVENTION

1. Field of the Invention

The invention relates to an electronic device and, more particularly, to an electronic device including an antenna.

2. Description of the Related Art

in order to maintain the wireless communication quality of as portable device, an antenna with good efficiency is needed. The portable device usually includes a dipole antenna or a monopole antennal disposed outside the device or integrated in the portable device. However, it is not easy to integrate the antenna to the portable device due to its large size.

Conventionally, the antenna is designed to adapt to different communication system by switching multiple matching circuits and radiating structures. However, an additional switch or a bias circuit is needed, which makes the antenna manufacture more complicated and the cost is increased.

A planar inverted F antenna (PIFA) is usually used as an internal antenna which is integrated in the portable device. As the portable device becomes lighter, smaller, and thinner, the space for laying the antenna becomes smaller. Since many components in the portable device is made of metal and the distance between the antenna and the metal components is short. The electric field of the antenna concentrates easily and the radiation loss of the antenna increases. Thus, it is more difficult to design an antenna which can operate at multiband communication system.

### BRIEF SUMMARY OF THE INVENTION

An electronic device is provided.

The electronic device includes a first conducting element, a second conducting element and a multiband antenna. The multiband antenna includes a first radiating part and a first coupling metal part. At least a part of the first radiating part is disposed between the first conducting element and the second conducting element. The first coupling metal part parallels to the first radiating part and is connected to a ground.

In sum, the affection on the antenna due to metal components in a portable device can be reduced, and the antenna can operate at more and wider frequency bands.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing an electronic device in the first embodiment;

FIG. 2 is a side view of the electronic device in FIG. 1;

FIG. 3 is a top view of the electronic device in FIG. 1;

FIG. 4 is a schematic diagram showing an electronic device in the second embodiment;

FIG. 5 is a schematic diagram showing an electronic device in the third embodiment;

FIG. 6 is a schematic diagram showing an electronic device in the fourth embodiment;

FIG. 7 is a schematic diagram showing an electronic device in the fifth embodiment; and

FIG. 8 is a schematic diagram showing an electronic device in the sixth embodiment.

### DETAILED DESCRIPTION OF THE EMBODIMENTS

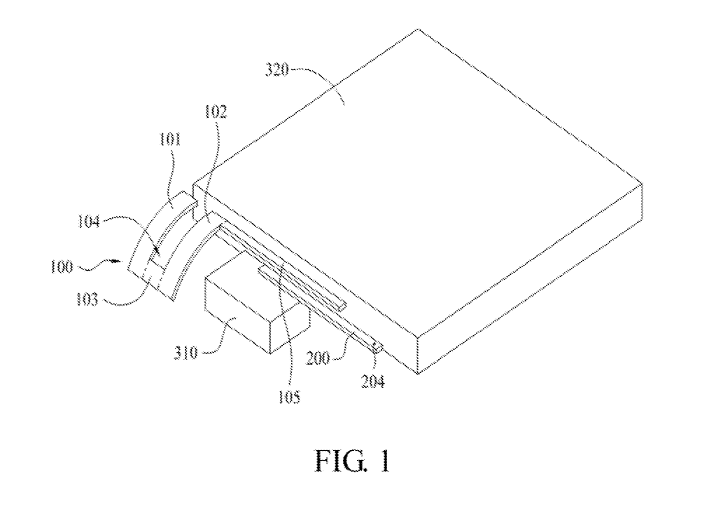

FIG. 1 is a schematic diagram showing an electronic device in a first embodiment. As shown in FIG. 1, the electronic device includes a first conducting element 310, a second conducting element 320 and a multiband antenna 100. The multiband antenna 100 includes a first radiating part 105 and a first coupling metal part 200. The first radiating part 105 is disposed between the first conducting element 310 and the second conducting element 320. Since the sizes of the first conducting element 310 and the second conducting element 320 may be different, at least a part of the first radiating part 105 is disposed between the first conducting element 310 and the second conducting element 320. The first coupling metal part 200 parallels to the first radiating part 105 and a ground point 204 is disposed at one end of the first coupling metal part 200.

The multiband antenna 100 includes a first metal part 101, a second metal part 102 and a third metal pan 103. The first metal part 101 parallels to the second metal part 102. One of the first metal part 101 and the second metal part 102 is used for signal feed-in, and the other one is connected to the ground. That means, when the first metal part 101 is used for signal feed-in, the second metal part 102 is connected to the ground. On the contrary, when the first metal part 101 is connected to the ground, the second metal part 102 is used for signal feed-in. In an embodiment, when the electronic device is applied to a portable device (such as a mobile phone), one of the first metal part 101 and the second metal part 102 is electrically connected to a signal line of a transceiver for signal feed-in, and the other one is electrically connected to a system ground of the portable. The third metal part 103 is connected between the first metal part 101 and the second metal part 102. The first metal pan 101, the second metal part 102 and the third metal part 103 forms an U shape, and an opening of the U shape which is formed by the first metal part 101, the second metal part 102 and the third metal part 103 extends towards the third metal part 103 to form a groove 104. Thus, if the length of the first metal part 101 and the second metal pan 102 increases, the length of the groove 104 also increases, and the length of the groove 104 can be changed to make the impedance of the multiband antenna 100 conform to a constant value (such as 50 Ω).

The first radiating part 105 of the multiband antenna 100 is connected to one end of the second metal part 102 which is not connected to the third metal part 103. the first radiating part 105 is coplanar with and perpendicularperpendicular to the second metal part 102, extends away from the groove 104 and it is along the first conducting element 310 and the second conducting element 320. The extending length of the first radiating part 105 can be changed to adjust a first frequency corresponding to a resonance mode. When the first radiating part 105 is shorter, the first frequency is higher.

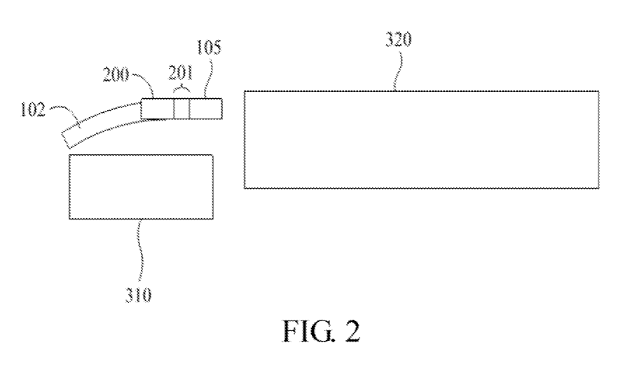

When the multiband antenna 100 operates, the first radiating pan 105 resonates to transmit or receive an electromagnetic signal. The end of the first radiating part 105 which is not connected to the second metal part 102 is easily shielded by the first conducting element 310, and the communication efficiency of the multiband antenna 100 is affected. FIG. 2 is a side view of the electronic device in FIG. 1. As shown in FIG. 1 and FIG. 2, the electronic device includes the first coupling metal part 200. The first coupling, metal part 200 is disposed in parallel with the first radiating part 105 and there is a distance 201 (about 0.1 mm to 1 mm) therebetween. The first coupling metal part 200 is near the end of the first radiating part 105 which is not connected to the second metal part 102, and the ground point 204 is connected to the ground. Thus, the first coupling metal part 200 and the first radiating part 105 can electromagnetically couple to each other and resonate at a second frequency. Due to the frequency bands corresponding to the first frequency and the second frequency, the electronic device can be applied at multiple frequency bands via the multiband antenna 100. In the embodiment, the frequency bands corresponding to the first frequency and the second frequency can be changed by adjusting the length of the first radiating part 105 and the first coupling metal part 200. When the frequency hands corresponding to the first frequency and the second frequency are overlapped, a broader frequency band is generated to enable the electronic device to be applied at multiple frequency bands via the multiband antenna 100.

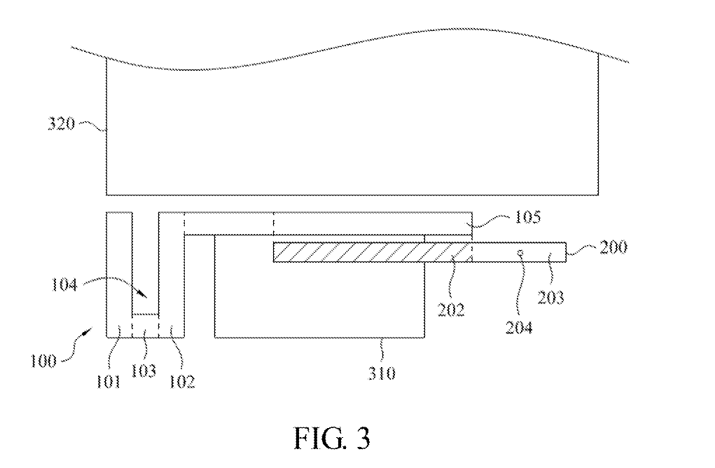

In the embodiment, in order to avoid affection from grounded metal components, when the first coupling metal part 200 and the first radiating part 105 are coupled to each other, the ground point 204 formed on the first coupling metal part 200 is not disposed at the orthographic projection part of the first radiating part 105 at the first coupling metal pan 200. FIG. 3 is a top view of the electronic device in FIG. 1. As shown in FIG. 3, the orthographic projection of the first radiating part 105 is at a section 202 of the first coupling metal part 200, and the ground point 204 is at another section 203 of the first coupling metal part 200.

As shown in FIG. 1, in the embodiment, the first metal part 101, the second metal part 102 and the third metal part 103 are attached to a casing (not shown) of the electronic device to fax the multiband antenna 100, and the surfaces of the first metal pan 101, the second metal part 102 and the third metal part 103 are determined by the attaching surface. Thus, the first metal part 101, the second metal part 102 and the third metal pan 103 may be arc elements, flat elements or any other elements with continuous surfaces.

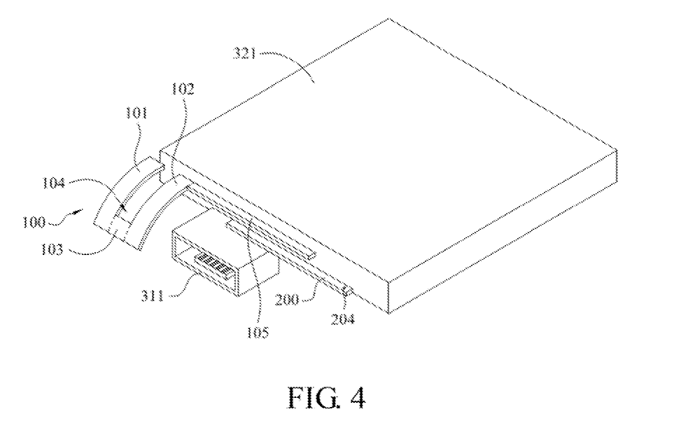

FIG. 4 is a schematic diagram showing an electronic device in the second embodiment. As shown in FIG. 4, when the electronic device is applied to a portable device (such as a mobile phone), the first conducting element 311 is a signal connector with a metal casing, such as a universal serial bus (USB) signal connector, a high-definition multimedia interface (HDMI) or a micro-USB signal connector. The metal casing protects the signal connector and is connected to the ground to avoid external interference or static electricity affection.

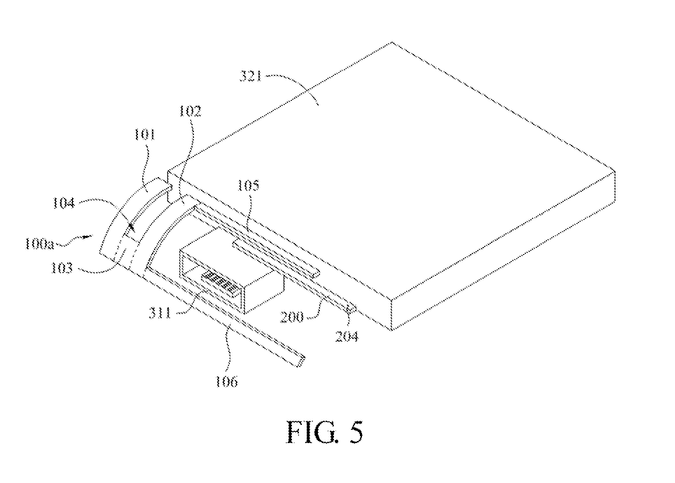

FIG. 5 is a schematic diagram showing an electronic device in the third embodiment. As shown in FIG: 5, the first radiating part 105 is perpendicularly connected to one end of the second metal part 102, and the electronic device further includes a second radiating part 106. The second radiating part 106 is connected to the other end of the second metal part 102, which is coplanar and perpendicular to the second metal part 102, and it parallels to the first radiating part 105. The first radiating part 105 and the second radiating part 106 are disposed at two sides of the first conducting element 311, respectively. The extending length of the second radiating pan 106 can be changed to adjust a frequency band corresponding to a third frequency, and the second radiating part 106 can resonate at the third frequency. The length of the first radiating part 105 can be changed to adjust the first frequency, the coupling effect between the first coupling metal part 200 and the first radiating part 105 can be changed to adjust the second frequency, and the length of the second radiating pan 106 can be changed to adjust the third frequency. Thus, the electronic device can be applied to multiband communication system via the multiband antenna 100a.

In the embodiment, the frequency bands corresponding to the first frequency, the second frequency and the third frequency can be changed by adjusting the length of the first radiating part 105, the first coupling metal part 200 and the second radiating part 106. When the frequency bands generated by the first frequency, the second frequency and the third frequency are overlapped or close to each other, a broader frequency band is formed. Thus, the electronic device can be applied to a broader band via the multiband antenna 100a, or the frequency bands are adjusted to meet different communication demands.

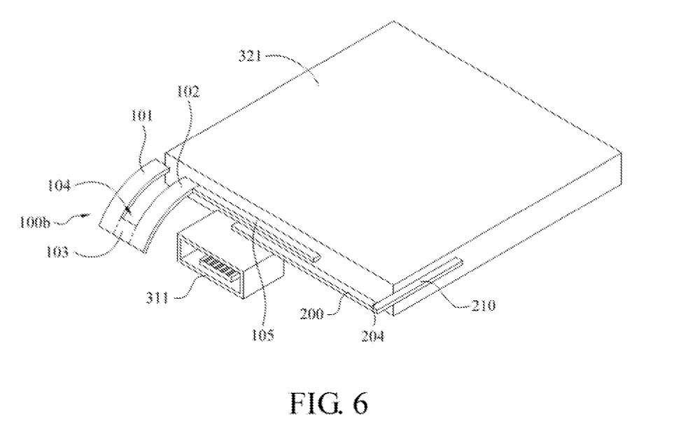

FIG. 6 is a schematic diagram showing an electronic device in the fourth embodiment. As shown in FIG. 6, the multiband antenna 100b further includes a second coupling metal part 210. The second coupling metal part 210 is connected to the first coupling metal part 200, coplanar and perpendicular to the first coupling metal pan 200, and the second coupling metal part 210 extends along the second conducting element 321, but it does not contact with the second conducting element 321. An extending length of the second coupling metal part 210 from the ground point 204 can be adjusted to generate the frequency band when the second coupling metal part 210 resonates at a fourth frequency.

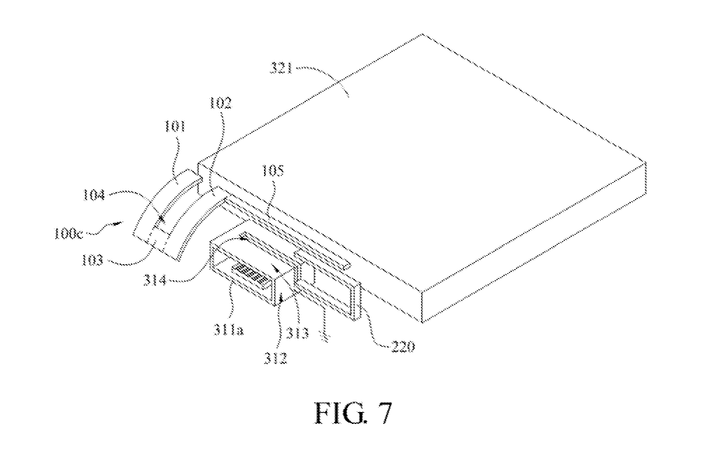

FIG. 7 is a schematic diagram showing an electronic device in the fifth embodiment. As shown in FIG. 7, the first coupling metal part 220 of the multiband antenna 100c is formed by a metal bar cut from the surfaces 312 and 313 of the metal casing of the first conducting element 311a. The metal bar cut from a part 314 at the surfaces 312 and 313 of the metal casing is folded and extends away from the first conducting element 311a. The end part of the metal bar parallels to the first radiating part 105 and does not contact with the first radiating, part 105. The end part of the metal bar is close to the end of the first radiating part 105, and when the first coupling metal part 220 and the first radiating part 105 couple to each other and resonate at the second frequency, the first coupling metal part 220 can be formed by the metal bar. The metal casing of the first conducting element 311a is connected to the ground, and thus the first coupling metal part 220 is connected to the ground via the metal casing of the first conducting element 311a. The electronic device and the first conducting element 311a can be integrated to a nodule and applied to a portable device.

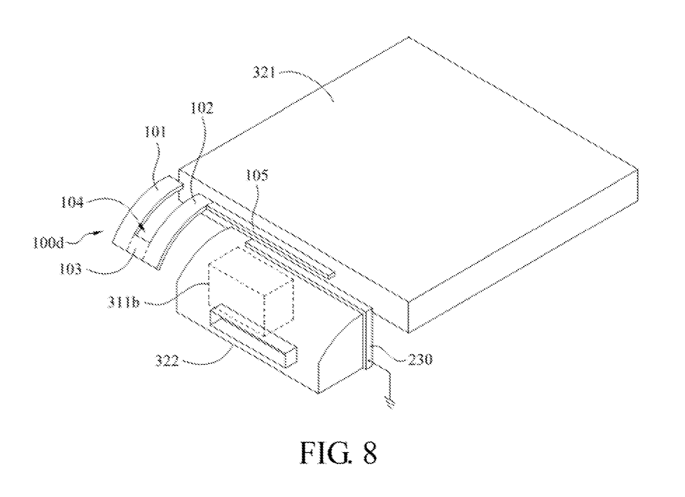

FIG. 8 is a schematic diagram showing an electronic device in the sixth embodiment. As shown in FIG. 8, the electronic device further includes an output module 322, and the first conducting element 311b is disposed in the output module 322. For example, the first conducting element 311b may be a loudspeaker coil or a camera, and the output module 322 may be a loudspeaker module or a camera module. When the electronic device is applied to a portable device, the output module 322 may include a nonmetal casing, such as a loudspeaker box or a plastic camera casing, to cover the first conducting element 311b, and the size of the second conducting element 321 is larger that of the first conducting element 311b. The first coupling metal part 230 of the multiband antenna 100d is fixed at the output module 322, and it is connected to the ground via the ground point thereon. The first coupling metal part 230 parallels to the first radiating part 105, but does not contact with the first radiating part 105. The first coupling metal part 230 is dose to one end of the first radiating pan 105, and thus they can couple to each other and resonate at the second frequency.

Although the present invention has been described in considerable detail with reference to certain preferred embodiments thereof, the disclosure is not for limiting the scope. Persons having ordinary skill in the art may make various modifications and changes without departing, from the scope. Therefore, the scope of the appended claims should not be limited to the description of the preferred embodiments described above.

What is claimed is:

1. An electronic device, comprising:
a first conducting element;
a second conducting element; and
a multiband antenna including:
a first radiating pan, wherein at least a part of the first radiating part is disposed between the first conducting element and the second conducting element; and
a first coupling metal part in parallel with the first radiating part and connected to a ground.

2. The electronic device according to claim 1, wherein the multiband antenna further includes:
a first metal part including a ground end;
a second metal art including a feed-in end and electrically connected to the first radiating part; and
a third metal part electrically connected to the first metal part and the second metal part.

3. The electronic device according; to claim 2, wherein the first metal part, the second metal part and the third metal part are arc elements.

4. The electronic device according to claim 1, wherein an orthographic projection of the first radiating part is partially overlapped to the first coupling metal part, and a ground point is formed on the first coupling metal part which is not located on the orthographic projection of the first radiating part.

5. The electronic device according to claim 2, wherein the first radiating part is perpendicularly connected to one end of the second metal part, and the multiband antenna further includes:
a second radiating part perpendicularly connected to the other end of the second metal part, wherein the first radiating part and the second radiating part are disposed at two sides of the first conducting element, respectively.

6. The electronic device according to claim 1, wherein the electronic device further includes:
a second coupling metal part perpendicularly connected to the first coupling metal part and extending along the second conducting element.

7. The electronic device according to claim 1, wherein the first coupling metal part is formed by a metal bar cut from a metal casing of the first conducting element, and the first coupling metal part is connected to the ground via the metal casing of the first conducting element.

8. The electronic device according to claim 1, wherein the first conducting element is a signal connector which includes a metal casing.

9. The electronic device according to claim 1, wherein the second conducting element is a battery made of metal.

10. The electronic device according to claim 1, wherein the electronic device further includes:
an output module, wherein the first coupling metal part is fixed at the output module, and the first conducting element is disposed in the output module.

11. The electronic device according to claim 10, wherein the output module is a loudspeaker or a camera.
